(19) United States
(12) Patent Application Publication
(10) Pub. No.: US 2015/0371571 A1
(43) Pub. Date: Dec. 24, 2015

(54) A Telecommunications Station Enclosure

(71) Applicant: TELEFONAKTIEBOLAGET L M ERICSSON (PUBL), Stockholm (SE)

(72) Inventor: Peter Häger, Djursholm (SE)

(21) Appl. No.: 14/650,525

(22) PCT Filed: Dec. 12, 2013
(86) PCT No.: PCT/SE2013/051501

§ 371 Date: Jun. 8, 2015

Related U.S. Application Data
(60) Provisional application No. 61/736,480, filed on Dec. 12, 2012.

(51) Int. Cl. G09F 15/00; H04N 5/64; G09G 5/36; G09F 13/00

(52) U.S. Cl. CPC G09F 15/0075; G09F 13/00; H04N 5/64; G09G 5/363; H04W 88/08

(57) ABSTRACT

The present invention relates to a telecommunications station enclosure (26) which comprises a panel assembly configured to essentially conceal a telecommunications station (24). The panel assembly is configured to conceal the telecommunications station at least partially with a sign or display (34) when the telecommunications station (24) is mounted on a vertical pole (22).

### TECHNICAL FIELD

The technology relates to telecommunications equipment and in particular to a telecommunications station enclosure.

### BACKGROUND

In a typical cellular radio system, wireless terminals (also known as mobile stations and/or user equipment units (UEs)) communicate via a radio access network (RAN) to one or more core networks. The radio access network (RAN) covers a geographical area which is divided into cell areas, with each cell area being served by a base station node, e.g., a radio base station (RBS), which in some networks may also be called, for example, a “NodeB” (UMTS) or “eNodeB” (LTE). A cell is a geographical area where radio coverage is provided by the radio base station equipment at a base station site. Each cell is identified by an identity within the local radio area, which is broadcast in the cell. Another identity identifying the cell uniquely in the whole mobile network is also broadcasted in the cell. The base stations communicate over the air interface operating on radio frequencies with the user equipment units (UE) within range of the base stations.

In some versions of the radio access network, several base stations are typically connected (e.g., by landlines or microwave) to a controller node (such as a radio network controller (RNC) or a base station controller (BSC)) which supervises and coordinates various activities of the plural base stations connected thereto. The radio network controllers are typically connected to one or more core networks.

In view of increased use and popularity of wireless products, radio networks are going to be densified in order to higher capacity demands. In order to position components of radio access networks more densely, suitable locations for the radio network structures must be found and procured. However, real estate is itself becoming more congested, and increasingly expensive. The places to install such equipment is becoming a significant hurdle, and the time for obtaining building permits often extends up to 20 months or more. So finding suitable sites, and acquiring rights or permission to use such sites, is becoming increasingly problematic.

### SUMMARY

The object of the invention is to provide a way to find places to install telecommunications stations in urban areas without requiring expensive rental of space or land or having trouble getting permissions due to protests against the aesthetic appearance. This is achieved by the arrangement as defined in the independent claims.

One of the aspects of the technology disclosed herein concerns a telecommunications station enclosure which comprises a panel assembly configured to essentially conceal a telecommunications station. The panel assembly is further configured to conceal the telecommunications station at least partially with a sign or display when the telecommunications station is mounted on a vertical pole.

Another aspect of the technology disclosed herein concerns a municipal pole structure used for carrying a telecommunications station and the telecommunications station enclosure according to aspect described above, wherein the municipal pole structure is adapted to allow firmly attachment to the ground in order to take the load of the telecommunications station and the enclosure to the ground.

Municipal poles such as light poles represent a suitable installation point for radio equipment since, e.g., both power and elevation exist. The problem with just bolting on this type of equipment to a light pole is that the visual congestion increases to such a degree that a municipality may not allow it. By covering up the RBS equipment in a package that make sense in urban or sub-urban environment, according to embodiments of the invention, the likelihood of having successful installations increases substantially.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a perspective view of a first example embodiment of a multimedia/multipurpose communications station positioned on a vertical pole, showing in broken lines a telecommunications station situated within a first example embodiment display communications enclosure of the communications station.

FIG. 2 is a perspective view of the multimedia/multipurpose communications station of FIG. 1 when positioned on a vertical municipal pole.

FIG. 3 is a perspective of a communications station which comprises a telecommunications station having plural modules arranged about the vertical pole in triangular placement.

FIG. 3A-3E are views of the telecommunications station of FIG. 3, with display communications enclosure removed, as seen from respective directions A-E, respectively of FIG. 3; FIG. 3F is a bottom perspective view of the communications station of FIG. 3.

FIG. 4 is a perspective view of a second example embodiment multimedia/multipurpose communications station positioned on a vertical pole, showing in broken lines a telecommunications station situation within a second example embodiment display communications enclosure of the communications station.

FIG. 4A is a perspective view of a modified second example embodiment multimedia/multipurpose communications station such as that of FIG. 4, but having ventilation through at least one of enclosure cap and enclosure skirt members.

FIG. 5 is a top sectioned view of an example embodiment multimedia/multipurpose communications station, showing ventilation of the telecommunications station within the display communications enclosure.

FIG. 6 is a side view of FIG. 5 taken along line 6-6.

FIG. 7 is a sectioned view of a portion of a panel of the display communications enclosure of the example embodiment of FIG. 4.

FIG. 8 is a cross sectioned view of the multimedia/multipurpose communications station of FIG. 4 and further illustrating hinged access to an interior of the station.

FIG. 9 is a side cross sectional view of a portion of the multimedia/multipurpose communications station of FIG. 4 in an implementation wherein a display of the display communications enclosure is remotely configurable.

FIG. 10A is a top left perspective view of a telecommunications station enclosure according to a first example embodiment.

FIG. 10B is a front view of the telecommunications station enclosure of FIG. 10A.

FIG. 10C is a top view of the telecommunications station enclosure of FIG. 10A.

FIG. 10D is a bottom view of the telecommunications station enclosure of FIG. 10A.

FIG. 10E is a right side view of the telecommunications station enclosure of FIG. 10A.

FIG. 10F is a left side view of the telecommunications station enclosure of FIG. 10A.

FIG. 10G is a perspective view of the telecommunications station enclosure of FIG. 10A in a municipal environment.

FIG. 11A is a top left perspective view of a telecommunications station enclosure according to a second example embodiment.

FIG. 11B is a front view of the telecommunications station enclosure of FIG. 11A.

FIG. 11C is a top view of the telecommunications station enclosure of FIG. 11A.

FIG. 11D is a bottom view of the telecommunications station enclosure of FIG. 11A.

FIG. 11E is a right side view of the telecommunications station enclosure of FIG. 11A.

FIG. 11F is a left side view of the telecommunications station enclosure of FIG. 11A.

FIG. 11G is a perspective view of the telecommunications station enclosure of FIG. 11A in a municipal environment.

### DETAILED DESCRIPTION

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

The main objective of the embodiments is to provide a way to find places to install telecommunications stations in urban areas without requiring expensive rental of space or land or having trouble getting permissions due to protests against the aesthetic appearance. That is achieved by a telecommunications station enclosure 26 comprising a panel assembly configured to essentially conceal said telecommunications station 24, and wherein the panel assembly is configured to conceal the telecommunications station at least partially with a sign or display (34) when the telecommunications station (24) is mounted on a vertical pole (22).

The vertical pole can be a municipal pole such as a light pole, and may be an already existing pole to which the telecommunications station enclosure is fastened and may utilize the poles power supply. The enclosure provides possibilities to easily set up telecommunications stations in urban areas with an appearance that is accepted by the public. The enclosure provides a display that can be used for advertising or messaging.

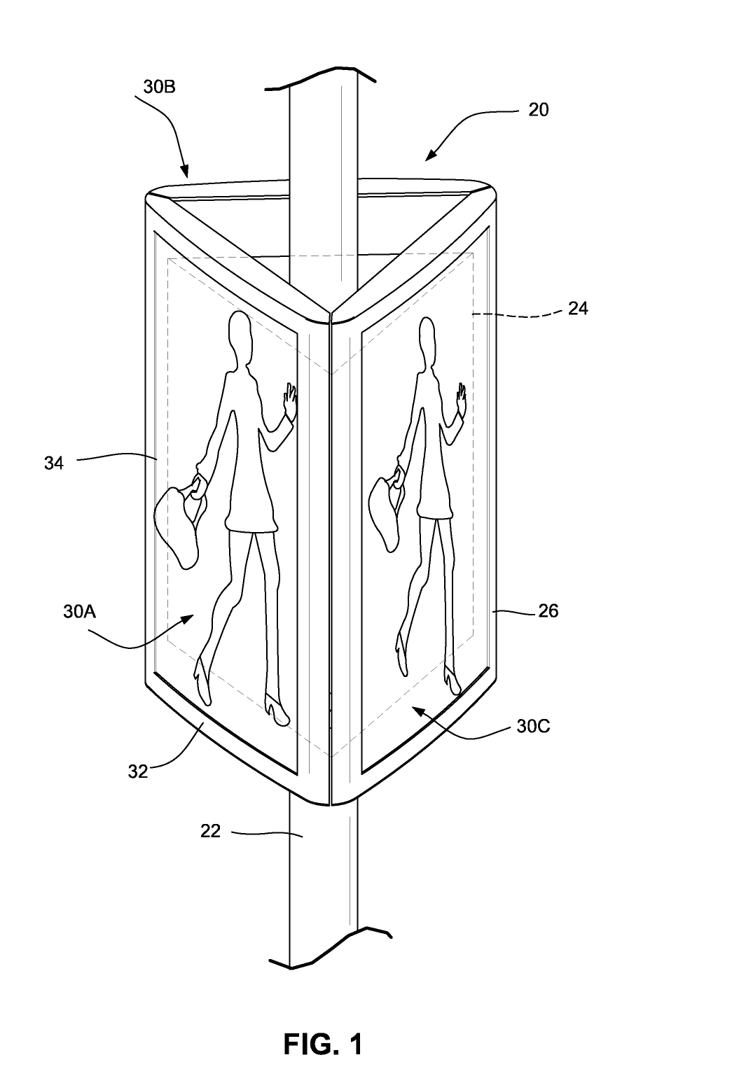

FIG. 1 is a perspective view of a first example embodiment of a multimedia/multipurpose communications station 20 positioned on the vertical pole 22. FIG. 1 shows in broken lines a telecommunications station 24 situated within communications enclosure 26 of communications station 20. The communications enclosure 26 is illustrated as comprising plural panels 30, which accordingly is also referenced as a “panel assembly”. The communications enclosure 26 is configured to at least partially conceal the telecommunications station 24 and, at least in some embodiments, to provide a display (thereby becoming a display communications enclosure). Particularly when bearing the display the communications enclosure 26 serves as a benign and beneficial parasite to both the telecommunications station 24 and to the vertical pole 22.

In some embodiments the communications enclosure 26 is also referenced as “telecommunications station enclosure”.

The multimedia/multipurpose communications station 20 with its internal telecommunications station 24 and outer communications enclosure 26 is depicted in FIG. 1 as having a generally triangular, prismatic shaped outer communications enclosure 26. However, the multimedia/multipurpose communications station 20 may also be constructed with other geometrical shapes (e.g., shapes having other geometries in a horizontal plane), such as rectangular, hexagonal, or even circular.

In an example, and as subsequently described, the telecommunications station 24 is attached to the vertical pole 22, and the communications enclosure 26 is in turn attached to telecommunications station 24. The communications enclosure 26 comprises plural panels 30 which are connected together, three such panels 30A, 30B, and 30C being illustrated by way of example in FIG. 1. Each panel 30 comprises a panel substrate 32; each substrate 32 is configured to, among other things, frame or surround a central panel display section 34. As described herein, the central panel display section 34 may bear or feature different modes of display and different types of subject/content of display. For sake of simplicity, the central panel display section 34 of FIG. 1 bears an image of a fashionable human female.

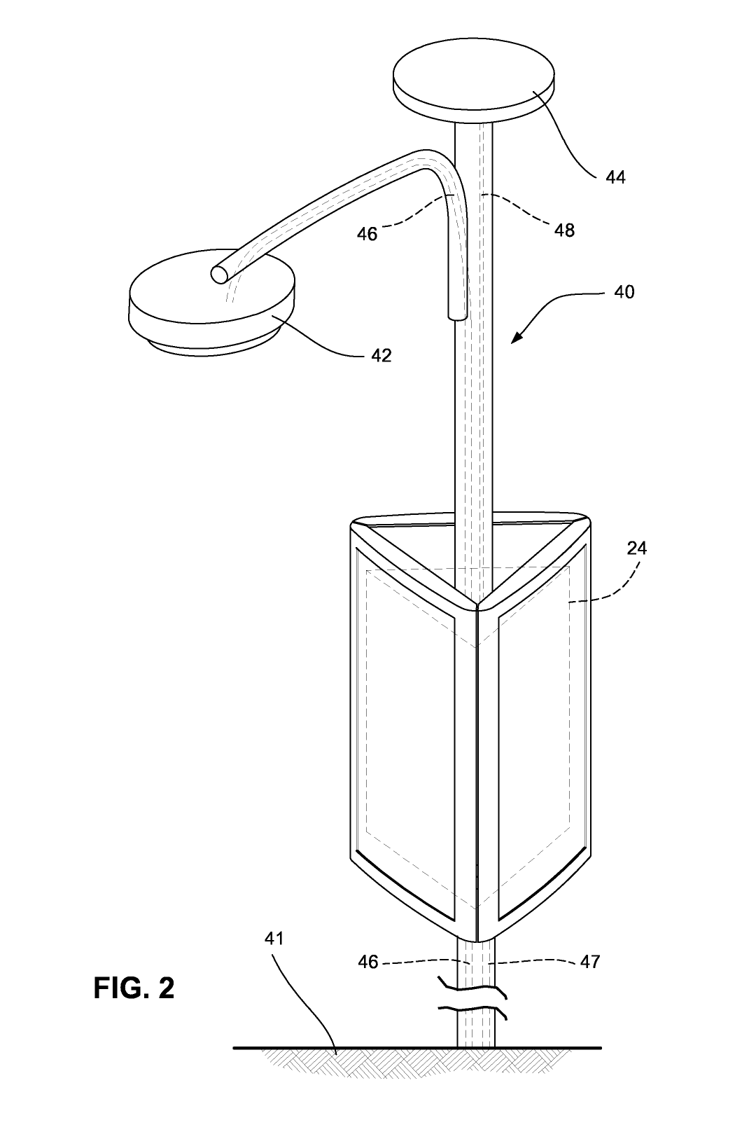

FIG. 2 illustrates that the multimedia/multipurpose communications station 20, and all embodiments of multimedia/multipurpose communications stations described herein or encompassed hereby, may be mounted to/on a vertical municipal pole. FIG. 2 thus illustrates a municipal pole structure 40 which is firmly attached to a horizontal grounding surface or structure 41, which may be ground, a foundation, or other pedestal in order to take the load of the telecommunications station and the enclosure to the ground. The municipal pole structure 40 comprises in one embodiment the vertically extending pole 22; a municipal utility service unit 42 positioned aloft on the pole 22; telecommunications station 24; and the communications enclosure 26 or panel assembly. In the particular example embodiment shown in FIG. 2 the municipal utility service unit 42 is a luminary device (e.g., street light). However, the municipal pole structure 40 may bear other types of municipal utility service units, such as power transmission devices or equipments, other types of communication equipment and/or accessories (e.g., telephone or other types of overhead cables), municipal signage. In some situations the municipal pole structure 40 may even comprise a portion of a larger structure, such as being a support pole for a bridge or other overhead or elevated structure. In this regard, it should be understood that, as used herein, “municipal” is not intended to imply government or civil ownership, although such is certainly encompassed. Rather, a “municipal pole” includes any vertical pole or vertical member that may provide a public service, whether government owned or not, such as a utility company or any other entity having an easement or right of way (e.g., for the public welfare or service).

As described herein, in some example embodiments the telecommunications station 24 comprises a radio frequency transmitter, receiver, or transmitter, such as a radio base station. In such example embodiments the municipal pole structure 40 may further comprise an antenna 44 mounted to, preferably surmounting, the vertical pole 22. Use of “antenna” in the singular does not limit the antenna 44 to a single antenna, as there may be plural antennae depending on the type of telecommunications station and nature of radio transmissions/environment involved. For example, the antenna 44 may be an omni-directional type of antenna which is well known in the telecommunications art.

When the municipal utility service unit 42 is of a type that is electrically powered, the vertical pole 22 carries electric power line(s) 46 for supplying power to municipal utility service unit 42. In addition, vertical pole 22 carries one or more power lines 47 to supplying electricity to telecommunications station 24, as well as one or more feeder lines 48 connecting the telecommunications station 24 to antenna 44. One or more of the electric power lines 46, power lines 47, and feeder lines 48 may be positioned in an interior (e.g., hollow portion) of vertical pole 22, or mounted or carried on the exterior of the vertical pole 22.

In the example embodiment of FIG. 2 the multimedia/multipurpose communications station 20, and thus the communications enclosure 26, is mounted aloft on the existing municipal pole approximately three meters above ground level. However, the altitude at which the multimedia/multipurpose communications station 20 is mounted may depend on various factors, such as (for example) radio frequency conditions and desired vantage of viewing of the display borne by communications enclosure 26.

As mentioned above, the multimedia/multipurpose communications station 20 comprises the communications enclosure 26, which in an example embodiment is a panel assembly connected to the telecommunications station 24. The panel assembly with its panels 30 is configured to essentially conceal the telecommunications station 24 and provide a display. Preferably, the communications enclosure 26 is configured to conceal the telecommunications station 24 at least partially with the display, e.g., to use the display to at least partially conceal or hide the telecommunications station 24.

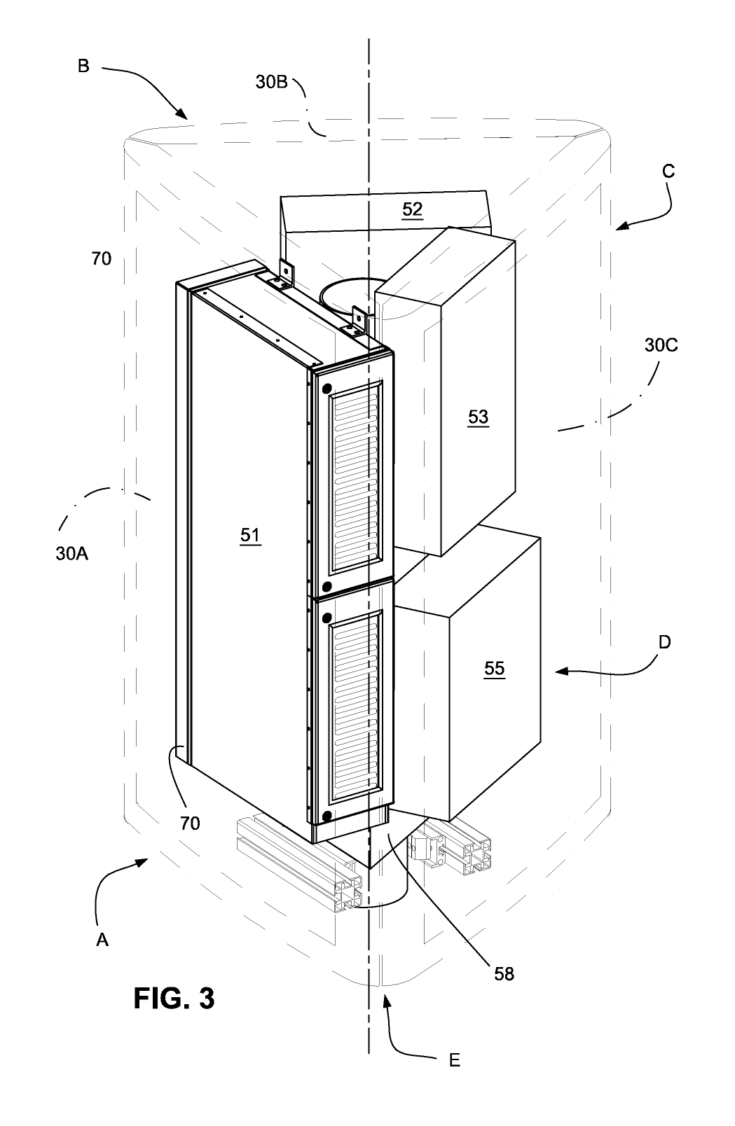

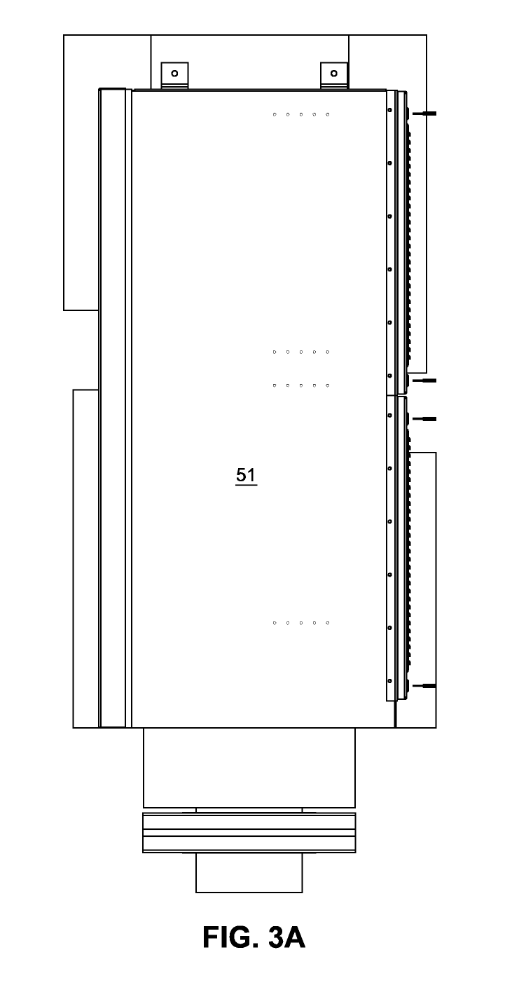

An example, non-limiting embodiment of a telecommunications station 24 which may be hidden or concealed by the communications enclosure 26 is illustrated in more detail in FIG. 3, as well as in FIG. 3A-FIG. 3F. In an example, non-limiting embodiment, the telecommunications station 24 may be a radio base station of a type which communicates over an air or radio interface with one or more wireless terminals. As such, the radio base station may be a macro radio base station, a micro radio base station (such as a “femto” or “pico” radio base station), or a relay station. Moreover, the telecommunications station 24 may be a station that participates in GSM, 3G, LTE, WiFi, wide local area networks (WLAN), or any other suitable radio communications convention, standard, or protocol, either in homogenous or heterogeneous networks. As used herein, a “wireless terminal” may encompass mobile stations or user equipment units (UE) such as mobile telephones (“cellular” telephones) and laptops with wireless capability, e.g., mobile termination, and thus can be, for example, portable, pocket, hand-held, computer-included, car-mounted, or machine-to-machine mobile devices which communicate voice and/or data with radio access network. In some example embodiments a wireless terminal need not be mobile but can instead be fixed. For example, for telecommunications purposes the multimedia/multipurpose communications station may serve parking meters, vending machines, or other consumer devices which remotely operate or report through wireless links.

The example telecommunications station 24 (radio base station) of FIG. 3 comprises plural modular units 51-55. The plural modular units of telecommunications station 24 are each essentially rectangular in shape, although not all having the same size or dimensions. For example, each of the plural modular units of telecommunications station 24 may be cabinets or containers housing different portions of a radio base station, or accessory or auxiliary units of/for the radio base station.

In an example implementation, modular units 52 and 53 may be cabinets which house radio transceiver components (e.g., RF transmitter(s) and RF receiver(s)) components of the radio base station. The number of such modular units housing radio transceiver components may vary depending, e.g., on a number of channels utilized or other capabilities of the radio base station. The modular units 52 and 53 are conveniently shown as located above units 54 and 55, respectively, positioning them closer to the antenna(ae) 44 to which they are connected by feeder lines 47. Examples of modular units 52 and 53 may be the Ericsson RRUS-01, RRUS-11, and RRUS-12, which are RF transceiver/power amplifier/duplexer filter units suitable for use with, for example, the Ericsson RBS6101/6102/6201/6202 base station platforms.

The modular unit 51 may be a cabinet or container for non-radio frequency components, e.g., may comprise a rack of circuit cards or circuit boards which in turn comprise other functionalities of the radio base station, such as one or more processors or controllers, digital switches, and interfaces (such as an interface to a radio access network (RAN) to which the radio base station belongs (e.g., to an radio network controller (RNC)), to a core network in case of flat networks such as Long Term Evolution (LTE), and to other radio base stations or other telecommunication units). In an example embodiment, the cabinet of modular unit 51 may have a vertical height of, for example, 8U, wherein “U” or “RU” (rack unit) is a telecommunications unit of length of about 1.75 inches (44.45 mm).

The modular units 54 and 55, located below modular units 52 and 53, may comprise power supply units (including, e.g., a power meter), a fiber connection box, and/or other units which comprise, support, or augment functionalities of the telecommunications station 24.

While each of the plural modular units of telecommunications station 24 happen to be illustrated as rectangular in shape, other shapes and sizes may also be possible. Preferably at least two larger size radio remote units (RRUs) may be accommodated within communications enclosure 26. If the radio remote units are of smaller size, more may be accommodate.

In the example embodiment of FIG. 3, the plural modular units of telecommunications station 24 are arranged in a triangular pattern about vertical pole 22.

There are various ways of mounting the multimedia/multipurpose communications station to the vertical pole 22. One way is to mount the telecommunications station 24 to the vertical pole 22, and then mount the communications enclosure 26 to the telecommunications station 24. Another way is to mount the communications enclosure 26 to the telecommunications station 24, and then mount the communications enclosure 26 to the pole. The person skilled in the art will realize that there several techniques for clamping structures to a vertical pole.

As one example technique for fastening the multimedia/multipurpose communications station 20 to the pole, one or more mounting brackets 58 may be utilized. As illustrated in FIG. 3F the mounting bracket 58 (also known as the central support member) has a triangular periphery as seen in cross sectional shape in a horizontal plane. The central support block 58 has a central, interior aperture 59 sized and configured to fit around the vertical pole 22. The central support block 58 may be formed as two mating parts that essentially connect or hinge together to form a collar around the vertical pole 22. The central support block 58 may extend sufficiently along the axis of vertical pole 22 so that at least portions of each of the plural modular units 51-55 are attached to one of the three peripheral faces of central support bracket 58 by suitable fastening mechanism The fastening mechanism may, in some example embodiments, be a direct bolting, clamping, or other affixation of the modular unit to the central support bracket 58. In other example embodiments the modular unit may be attached by an intermediate structure, such as a connector or spacer bracket, to central support bracket 58. The central support bracket 58 extends to a lower altitude on vertical pole 22 than does the remainder of telecommunications station 24. Beneath the plural modular units 51-55 the central support bracket 58 may connect to two clamp carriage rails 62. The clamp carriage rails 62 are parallel to one another in a horizontal plane beneath central support block 58, and comprise pole-facing tracks 64 in which two selectively positionable clamps 66 may slide or be tightened into position. FIG. 3E shows, e.g., how the clamps 66 are positioned (e.g., using fasteners) to have ramped surfaces thereof bear against the periphery of the vertical pole 22 and thereby maintain central support block 58, as well as the entire multimedia/multipurpose communications station 20 supported thereby, at a desired altitude on vertical pole 22. The central support block 58 has a central, interior aperture 59 sized and configured to receive the vertical pole 22. When tightened into position, the clamps 66 bear against the periphery of vertical pole 22 and lock the multimedia/multipurpose communications station at a desired altitude.

Thus, as understood from FIG. 3, the communications enclosure 26 or panel assembly comprises plural panels 30 which are positioned to substantially vertically enclose the plural modules 51-55. At least one and preferably more than one (e.g., all) of the plural panels bear a same or different signage.

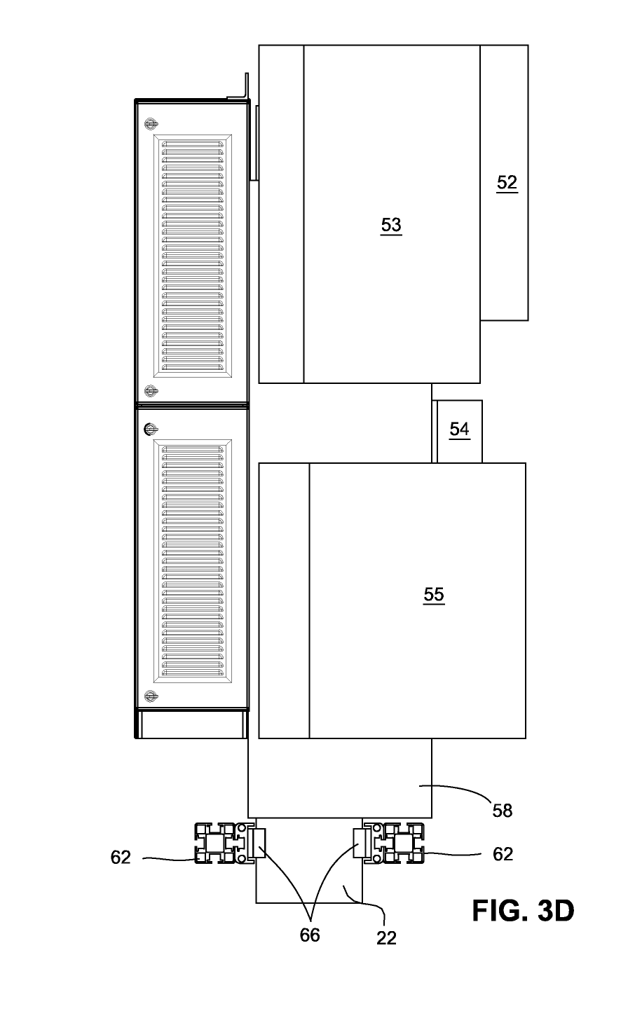

In an example embodiment, one of the plural panels, such as panel 30A, is an anchor panel and one of the plural modules, such as module 51, is an anchor module. The anchor panel 30A is mounted to the anchor module 51. For example, FIG. 3 shows how anchor panel 30A may be mounted to anchor module 51 by fasteners 70. The fasteners 70 may take the form of bolts or threaded screws, for example. The fasteners 70 are preferably positioned so as not to interfere with or obstruct the central panel display section 34 of anchor panel 30A. The others of the plural panels (e.g., panels 30B and 30C) are connected to the anchor panel 30A, for example at vertically extending intersections. In an example embodiment, the plural panels of communications enclosure 26 are connected to one another at the vertically extending intersections by hinges 72 (see FIG. 5) so that the panel assembly of communications enclosure 26 is wrapped about exterior vertical surfaces of at least some of the plural modules 51-55 of the telecommunications station 24.

Thus, from the foregoing it will be understood that the plural modular units 51-55 may be positioned at different angles about vertical pole 22 and about central support block 58. Moreover, the plural panels are connected in a manner whereby the panel assembly in a horizontal plane forms a geometric shape about a vertical axis of vertical pole 22. It so happens that in the example illustrated embodiments the geometric shape is a triangle. In an example embodiment, the geometrical shape is configured to have sides which are parallel to vertical surfaces of the plural modules which are surrounded by the panel assembly.

FIG. 5 shows, from cut away from above, an interior of multimedia/multipurpose communications station 20 according to an example embodiment. FIG. 5 thus also depicts the mounting of anchor panel 30A to anchor module 51 by fasteners 70, and the connection (by hinges 72) of panels 30B and panel 30B to the anchor panel 30A. Further, FIG. 5 illustrates that the geometrical shape of the communications enclosure 26 is configured to have sides (e.g., panels 30) which are parallel to vertical surfaces of the plural modules which are surrounded by the panel assembly. The panel assembly may be closed in its triangular configuration by a clasp 74 or other suitable fastener.

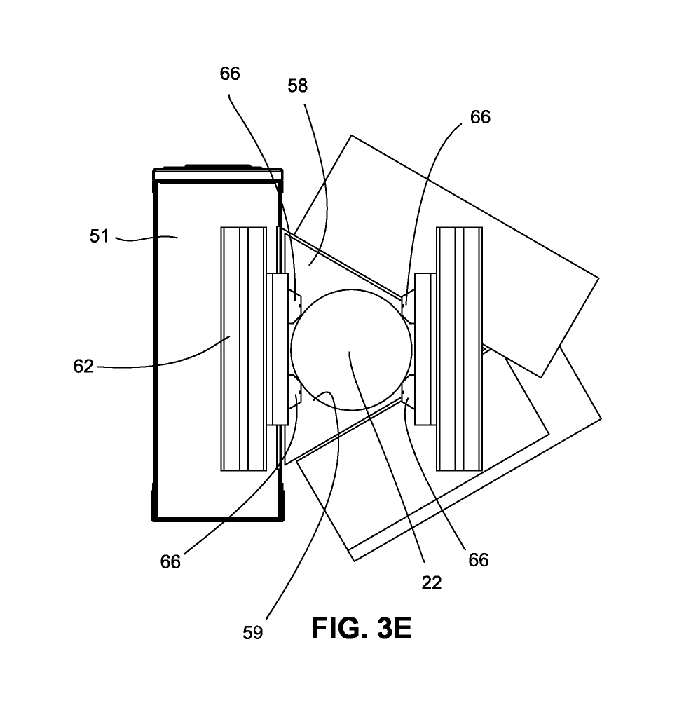

Yet further, FIG. 5 illustrates that at least one of the plural modular units 51-55 of telecommunications station 24 comprise an air inlet/air filter 80 and a ventilation or cooling fan 82. In the particular implementation of FIG. 5, the air inlet/air filter 80 extends in a vertical plane parallel and on a first end wall of anchor modular unit 51, and ventilation or cooling fan 82 is positioned on a second end wall of anchor modular unit 51 (opposite the first end wall). FIG. 5, together with FIG. 6, also show that vents or openings 84 are provided in communications enclosure 26 so that air may be impelled by ventilation or cooling fan 82 through the vents or openings 84 of communications enclosure 26, through the air inlet/air filter 80 and out the second end wall of anchor modular unit 51, as indicated by air flow arrows 86. The air flow represented by air flow arrows 86 may circulate around others of the plural modular units 52-55, and may be discharged either above or below the communications enclosure 26 in some embodiments, or through exhaust vents or openings 88 provide at other locations in communications enclosure 26. The vents or openings 84 may be located, for example, at vertical edges of the panels 30, e.g., at the vertical intersections (e.g., joints) of adjacent panels. The vents or openings 84 and air flow arrows 86 may comprise apertures, louvers, or screens, for example.

Thus, the multimedia/multipurpose communications station 20 is free cooled with filtered air. The air is routed from outside of the panels 30 into the cabinet interior of module 51, and then from the cabinet of module 51 to the inside of the panels 30, later allowing the air to seep out through the exhaust vents or openings or joints 88 in the panels. This creates an air movement within the panels 30 which helps cool other equipment mounted behind the panels, e.g., the plural modular units 51-55.

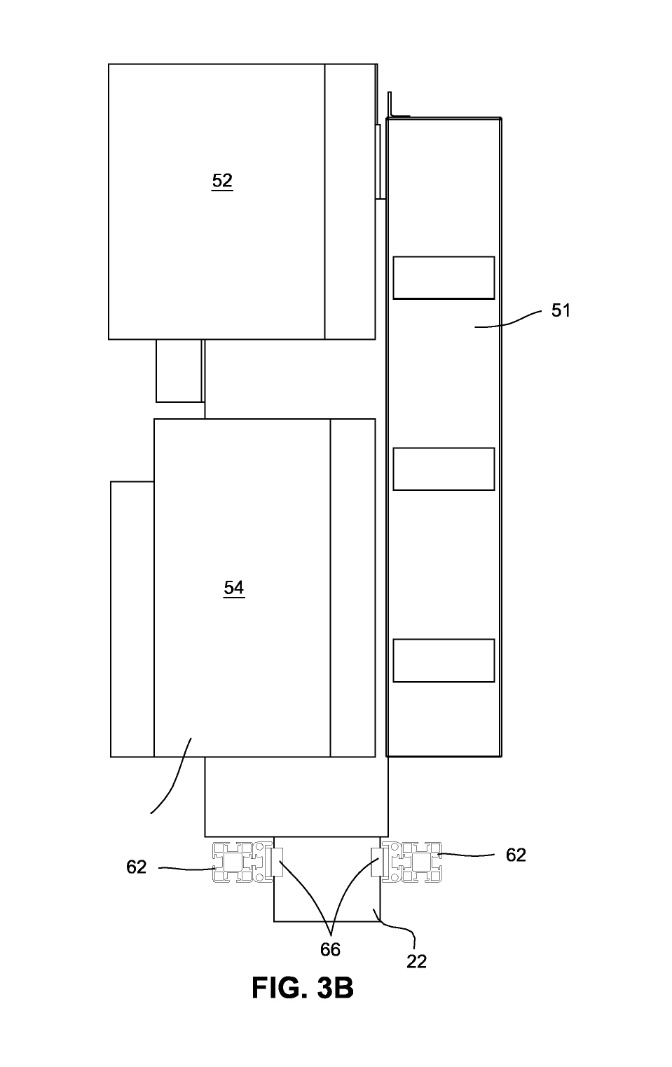

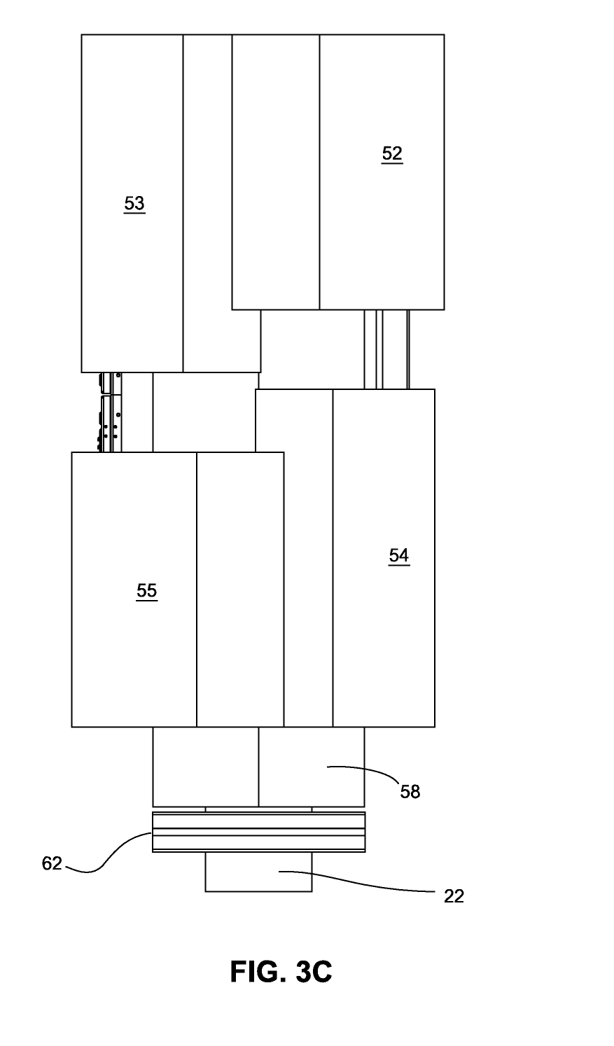

FIG. 4 illustrates an example embodiment of a multimedia/multipurpose communications station 20′ which differs from the multimedia/multipurpose communications station 20 of FIG. 1 in that the communications enclosure 26 additionally comprises one or both of an enclosure cap 90 and an enclosure skirt 92. In other words, the panel assembly of the communications enclosure 26 of multimedia/multipurpose communications station 20′ comprises enclosure cap 90 which encloses the panel assembly horizontally above the telecommunications station 24, and enclosure skirt 92 which encloses the panel assembly horizontally below the telecommunications station 24. The enclosure cap 90 and enclosure skirt 92 are essentially conical, with enclosure cap 90 having the orientation of an upstanding cone while enclosure skirt 92 has the orientation of an inverted cone. Stated differently, at increasing distances from a horizontal center of the panel assembly the enclosure cap 90 and the enclosure skirt 92 taper in horizontal cross sections toward a vertical center of the panel assembly.

The communications enclosure 26 is in some embodiments referenced as a telecommunications station enclosure.

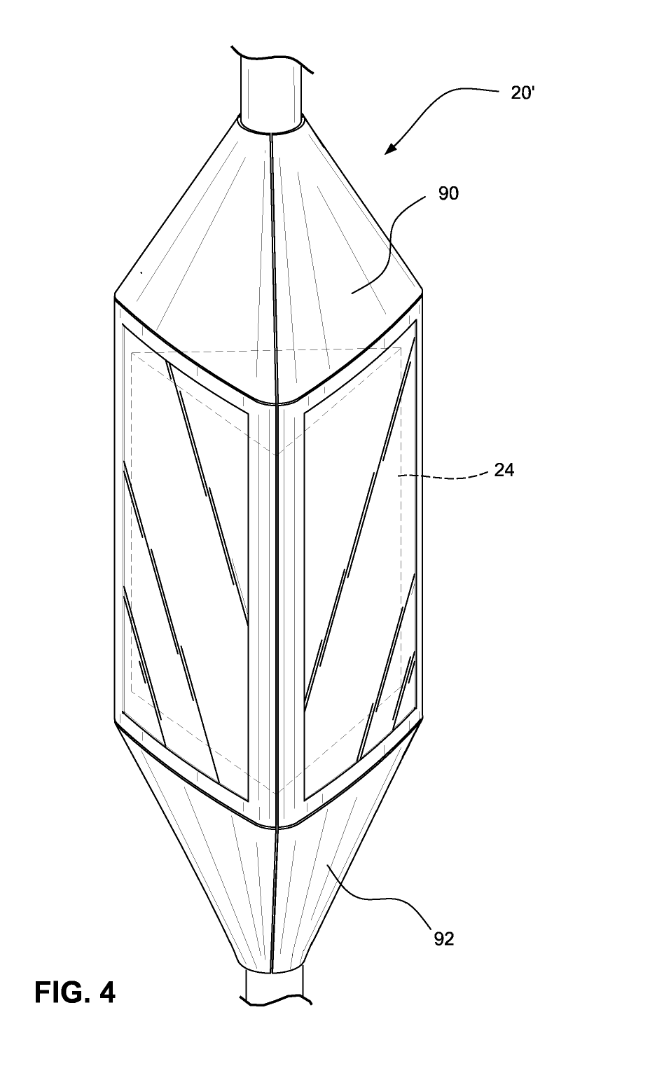

In an example embodiment the enclosure cap 90 and enclosure skirt 92 may be formed integrally with a respective one of the plural panels 30, e.g., may be formed as extensions of one or more of the panels 30. For example, FIG. 8 illustrates that a center portion of panel 30A forms the vertical display wall, but terminal segment 90A and 92A extend in other planes to form the enclosure cap 90 and enclosure skirt 92 respectively.

FIG. 8 illustrates an example embodiment wherein at least one of enclosure cap 90 and enclosure skirt 92 are formed as extensions of panels 30. From FIG. 8 it may be understood that enclosure cap 90 may be secured to vertical pole 22 through similar mechanism as is telecommunications station 24 therebelow, e.g., using clamp carriage rails 62 bearing slidable clamps 66, for example. The enclosure cap 90 may be attached to clamp carriage rails 62 through intermediate structure such as a support block (similar to central support block 58) or other members. While some of the panels 30 comprising the communications enclosure 26 may have vertical interfaces in the manner previously discussed, for the example of FIG. 8 at least one panel (e.g., panel 30A) does not have vertical connections to adjacent panels but is instead connected to enclosure cap 90 by a hinge 94. Thus, in the example embodiment of FIG. 8, center portion of panel 30A with its integral skirt segment 92A may pivot about hinge 94, thereby permitting access to the interior of multimedia/multipurpose communications station 20 and to telecommunications station 24. To assist such pivoting, the communications enclosure 26 may be provided with a pneumatic spring 96

FIG. 4A shows a variation of the multimedia/multipurpose communications station 20′ of FIG. 4, showing that one or both of enclosure cap 90 and enclosure skirt 92 may be provided with ventilation means for the multimedia/multipurpose communications station 20′. For example, one or both of enclosure cap 90 and enclosure skirt 92 may be provided with vents, louvers, or screens 98 as shown in FIG. 4A. Such vents, louvers, or screens 98, either in conjunction with or alternative to the vents or openings 84 and air flow arrows 86 of FIG. 5, may allow ingress or egress of air flow so that cooling may occur substantially in the manner illustrated in FIG. 5.

In some example embodiments, the communications enclosure 26 is a communications enclosure 26 and as such may bear a sign or display which, e.g., may at least partially hide or conceal the telecommunications station 24 which it essentially surrounds. The display function may realized in any of several display modes and be of essentially any desired content or subject matter. For example, the display may be a still image, photographically or otherwise produced, such as the image of the fashionable human female shown in FIG. 1. In some example embodiments such image may be in the form of one or more segments of static artwork which is/are adhered, attached, secured, or integrally formed to/with central panel display section 34 of communications enclosure 26. In example implementations such display is preferably illuminated, at least on some occasions (e.g., selectively illuminated), by direct lighting or backlighting, for example. In other example embodiments the display may be electronically driven, e.g., the central panel display section 34 may comprise an LCD screen which is driven to produce a desired image, whether static or dynamic.

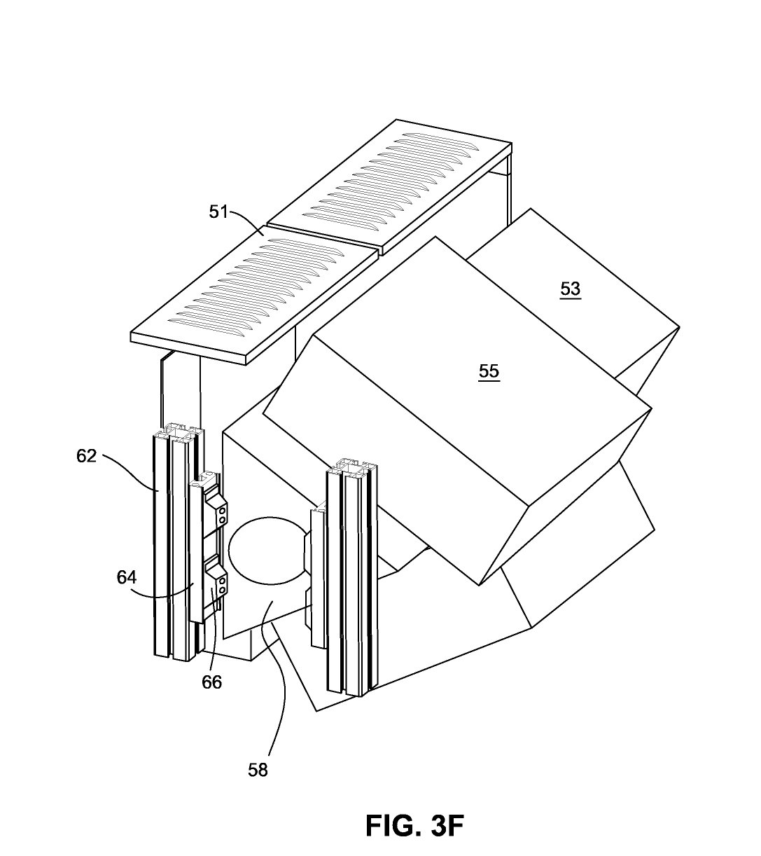

FIG. 7 shows an example panel 30 of the type which may comprise the communications enclosure 26 of FIG. 4, for example. Although having the enclosure cap 90 and enclosure skirt 92 of FIG. 4, the panel 30 as shown in cross section in FIG. 7 also provides an understanding of the structure of the plural panels that comprise the communications enclosure 26 of other embodiment such as FIG. 1.

The panel 30 of FIG. 7 has a fiber glass substrate 110 which into which a channel 112 has been formed, only partially through a center portion of the substrate 110. Preferably the substrate 110 has a coating, such as Gelcote, for example. In the vicinity of the channel 112 the substrate 110 may, in an example embodiment, be about 6 mm thick. The position of the channel 112 essentially corresponds to the central panel display section 34. In the example embodiment of FIG. 7, the channel 112 is sized to accommodate a light emitting diode (LED) panel 114. The LED panel 114 may have a thickness on the order of about 0.14 mm. The LED panel 114 is in turn overlaid with a protective glass or plastic coating 116 or translucent polycarbonate. The protective coating 116 may be about 4 mm thick and is preferably translucent, or at least partially or semi-translucent. In at least some example embodiments, an adhesive film 118 may be applied to an outer surface of the 118 to facilitate attachment of an image, display, or sign, generically represented by the image of the fashionable human female in FIG. 1.

Thus, the wireless terminal 30 comprises an at least semi-translucent panel section (e.g., central panel display section 34) which bears the display. Being mounted on the vertical pole 22, the display is preferably oriented to be viewed from an exterior of communications enclosure 26. In at least some example embodiments, the communications enclosure 26 comprises an illumination source for directing light toward the translucent panel section. In the embodiment of FIG. 7, for example, the illumination source is in the interior of the communications enclosure 26, e.g., the LED panel 114.

An illumination source such as LED panel 114 requires electrical power. In an example embodiment, the illumination source may obtain power from the telecommunications station 24. In an example embodiment, the multimedia/multipurpose communications station 20 has a common power supply that powers the illumination source and the telecommunications station 24. In an example, non-limiting implementation, the multimedia/multipurpose communications station 20, or municipal pole structure 40, may further comprise a solar panel which provides power for the illumination source. In one example implementation one or more solar panels may be held aloft by vertical pole 22 in like manner as antenna 44. In another example embodiment, a solar panel may be borne by one of the panels 30 (instead of and/or in addition to bearing a display).

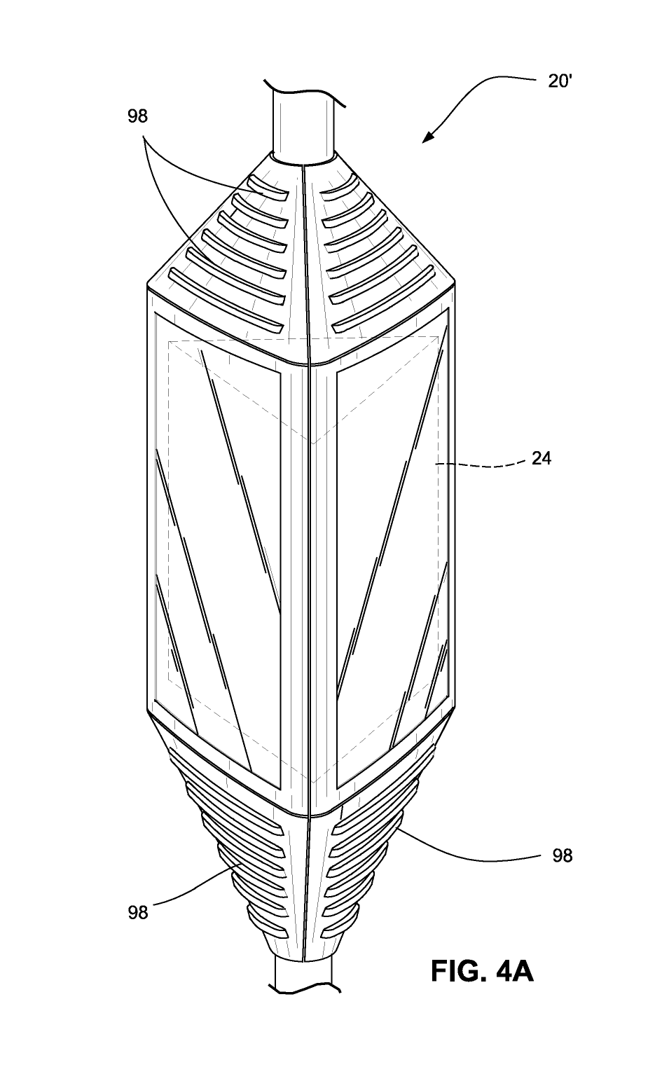

FIG. 9 depicts an example embodiment in which at least one panel 30 of the panel assembly comprises a display panel assembly 120 which is driven/programmed to provide the display. As in FIG. 7, the panel 30 comprises substrate 110 which has channel 112 formed or otherwise provided therein. A circuit board 122 is vertically oriented and secured in the channel 112. The channel 112 has mounted thereon both display driver circuit 124 and a display region 126 (comprising display elements such as display pixels, etc.). The circuit board 122, with the display driver circuit 124 and display region 126 mounted thereon, are overlaid by protective coating 116 (a cover glass or plastic, or translucent polycarbonate, as before described).

FIG. 9 further illustrates that the display panel assembly 120 may be remotely driven so as to, for example, change image(s) displayed on the display region 126. To facilitate such remote driving, the display driver circuit 124 may be connected to a communication module 130 which is additionally included in telecommunications station 24. The communication module 130 in turn comprises a processor and an interface to receive remotely originated display drive signals. The interface may be a wired interface or, as illustrated in FIG. 9, a transceiver 134 which transmits and receives over the air or radio interface. In the case of a wireless terminal with transceiver 134, the communication module 130 may be served by the radio base station of telecommunications station 24, and thus it may be through telecommunications station 24 that the communication module 130 receives information which is applied to display driver circuit 124 to drive the display region 126, and thus generate the remotely originated, and even moving image, on display region 126. In this manner the content of the central panel display section 34 may be selectively changed, or even streaming with information to provide a program or other dynamic presentation. The display region 126 may be any suitable type of display, such as an liquid crystal display, a plasma display, a light-emitting diode (LED) display, or an organic light-emitting diode (OLED) display, for example.

The subject matter which is displayed or portrayed or held aloft by central panel display section 34 of communications enclosure 26 may be of any suitable type. For example, the content or subject matter may comprise advertising, an advisory notice (such as a traffic advisory or speed limit), a municipal announcement or information, or a video program.

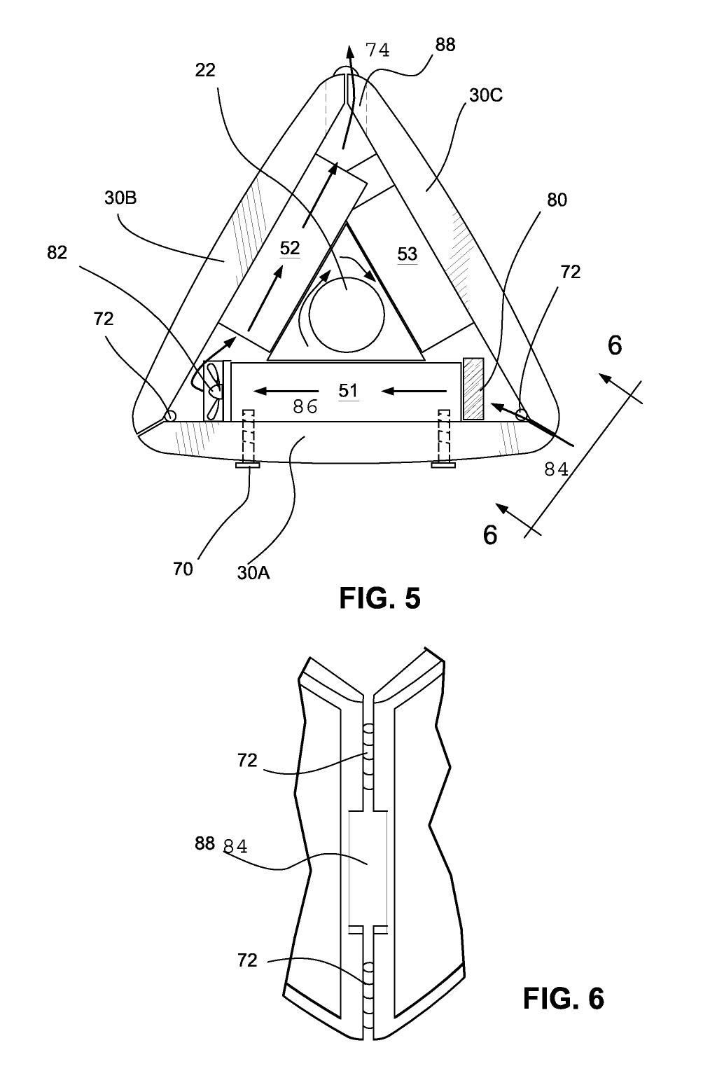

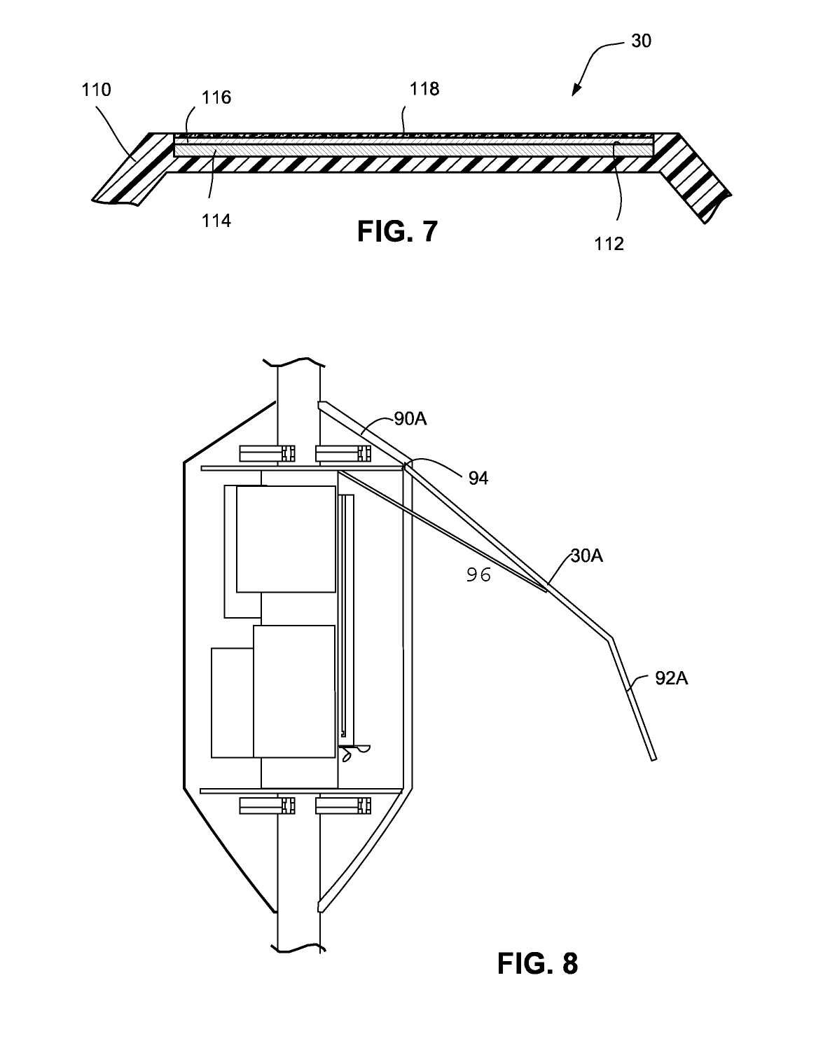

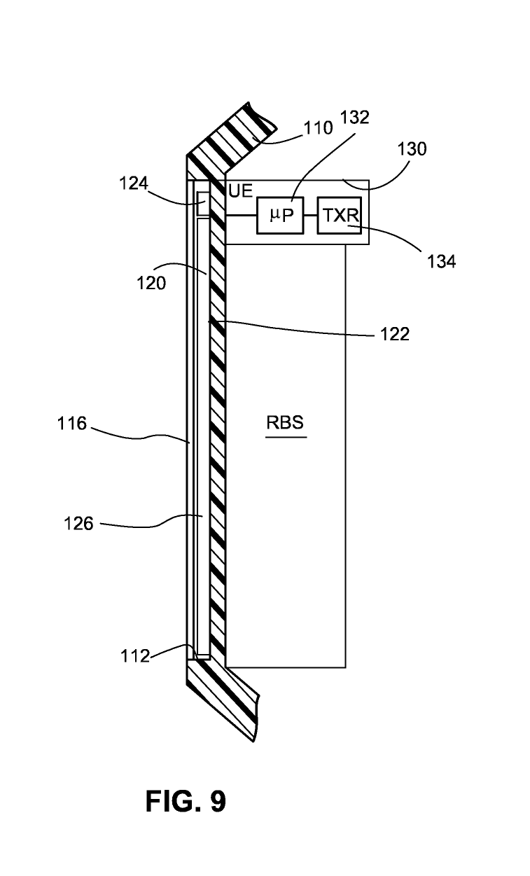

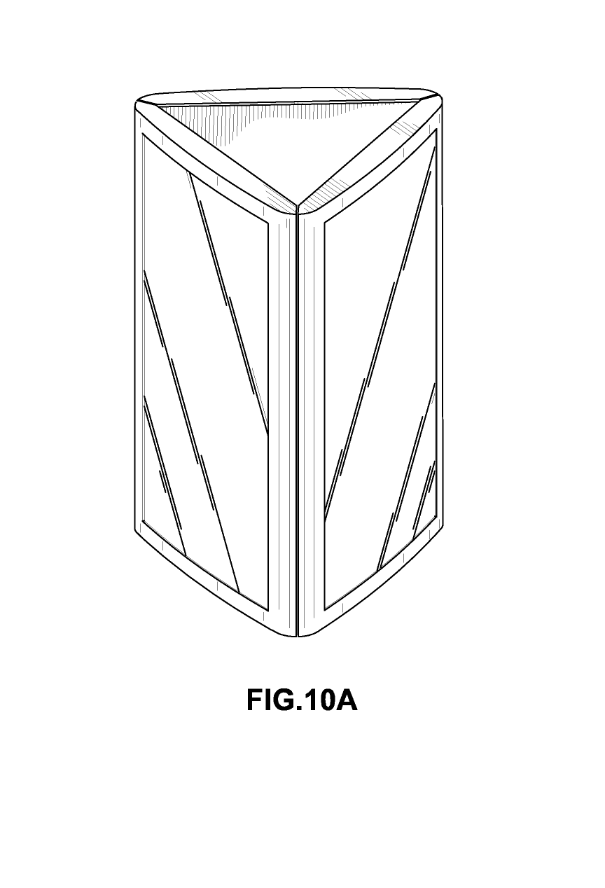

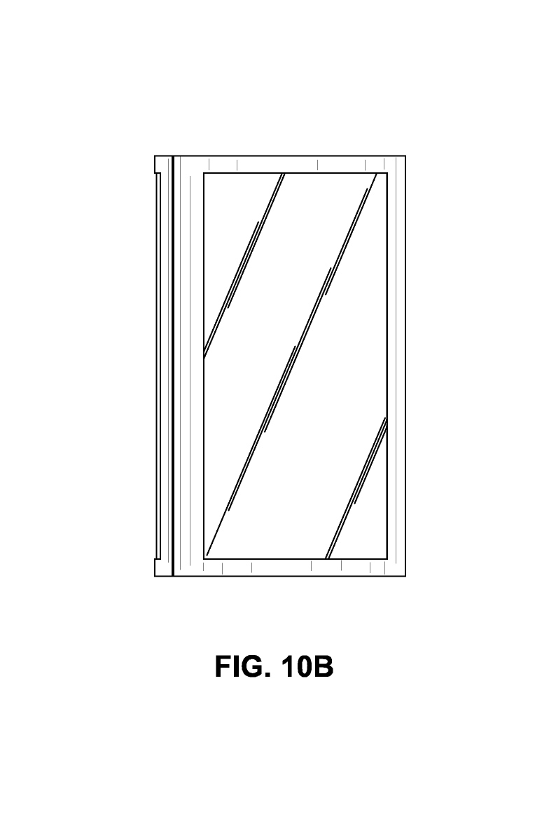

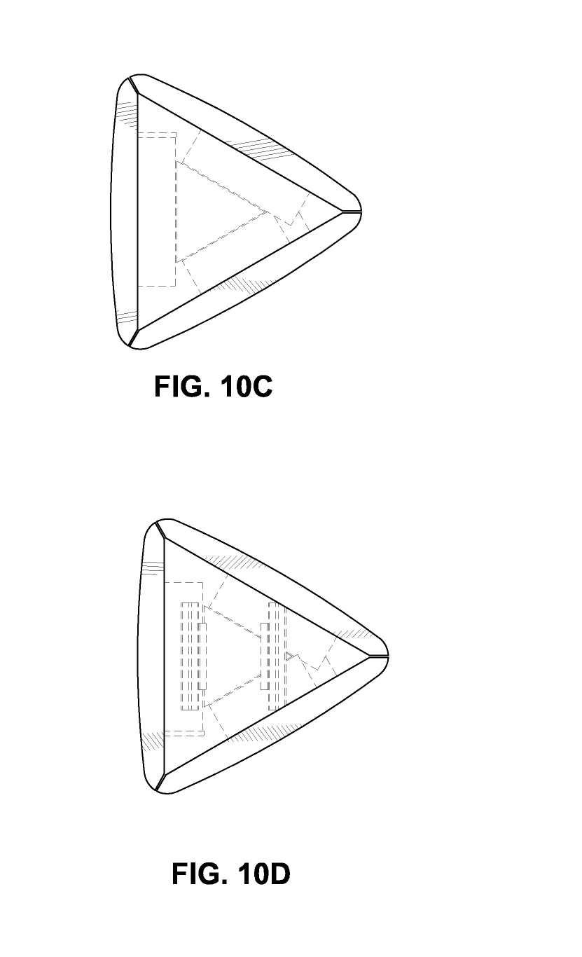

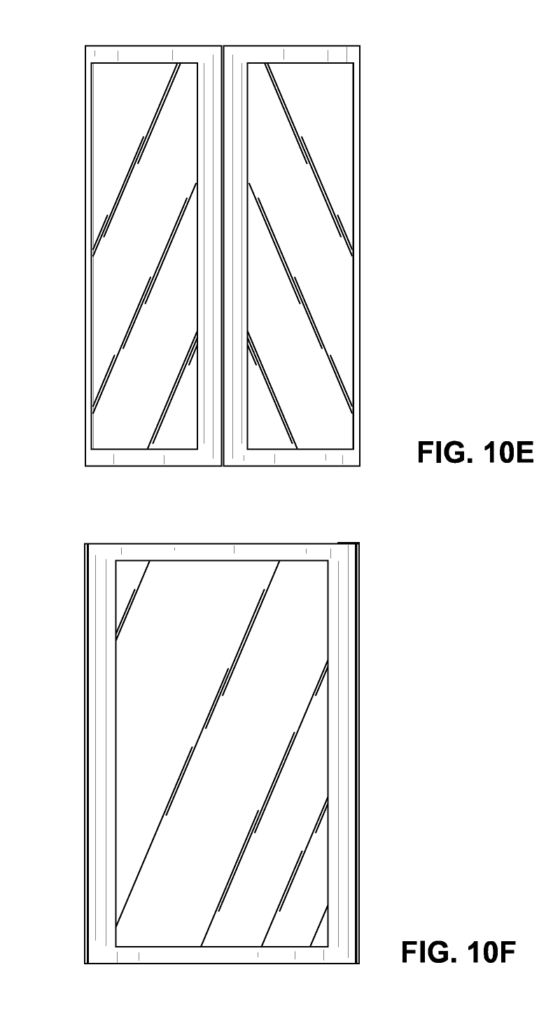

The display communications enclosures for the pole-mounted telecommunications equipment as described herein have aesthetic and pleasing qualities. External appearance of the multimedia/multipurpose communications station 20, and of a telecommunications station enclosure, of an embodiment such as that of FIG. 1 from various vantage points or views is provided in FIG. 10A-FIG. 10F. FIG. 10A is a top left perspective view of a telecommunications station enclosure; FIG. 10B is a front view of the telecommunications station enclosure of FIG. 10A; FIG. 10C is a top view of the telecommunications station enclosure of FIG. 10A; FIG. 10D is a bottom view of the telecommunications station enclosure of FIG. 10A; FIG. 10E is a right side view of the telecommunications station enclosure of FIG. 10A; and, FIG. 10F is a left side view of the telecommunications station enclosure of FIG. 10A. FIG. 10G is a perspective view of the telecommunications station enclosure of FIG. 10A in a municipal environment.

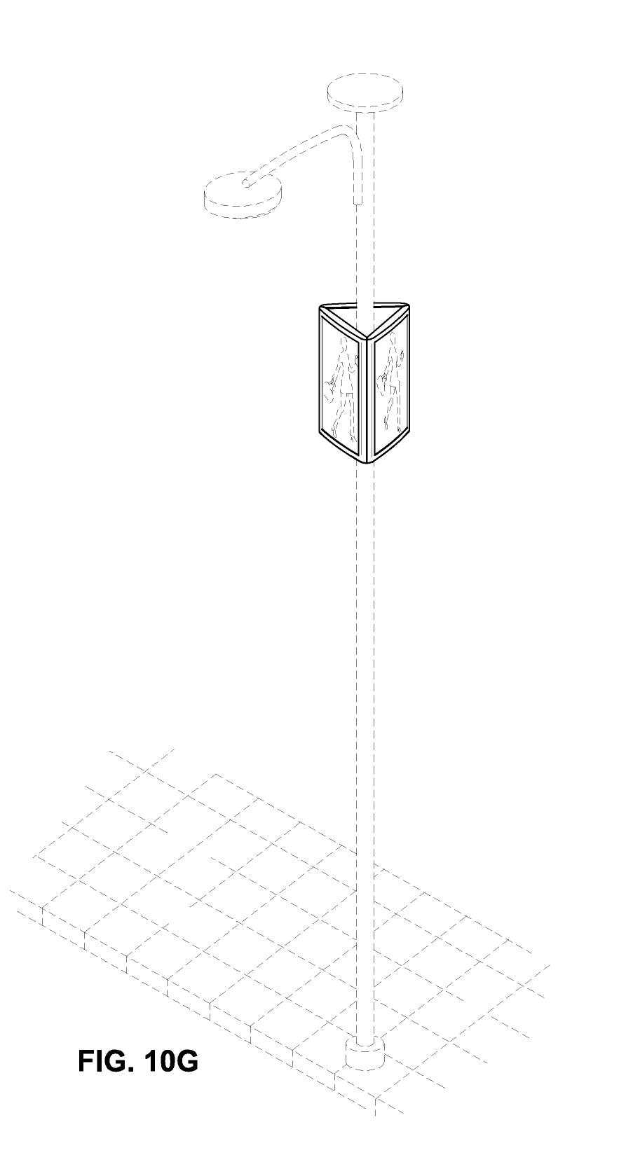

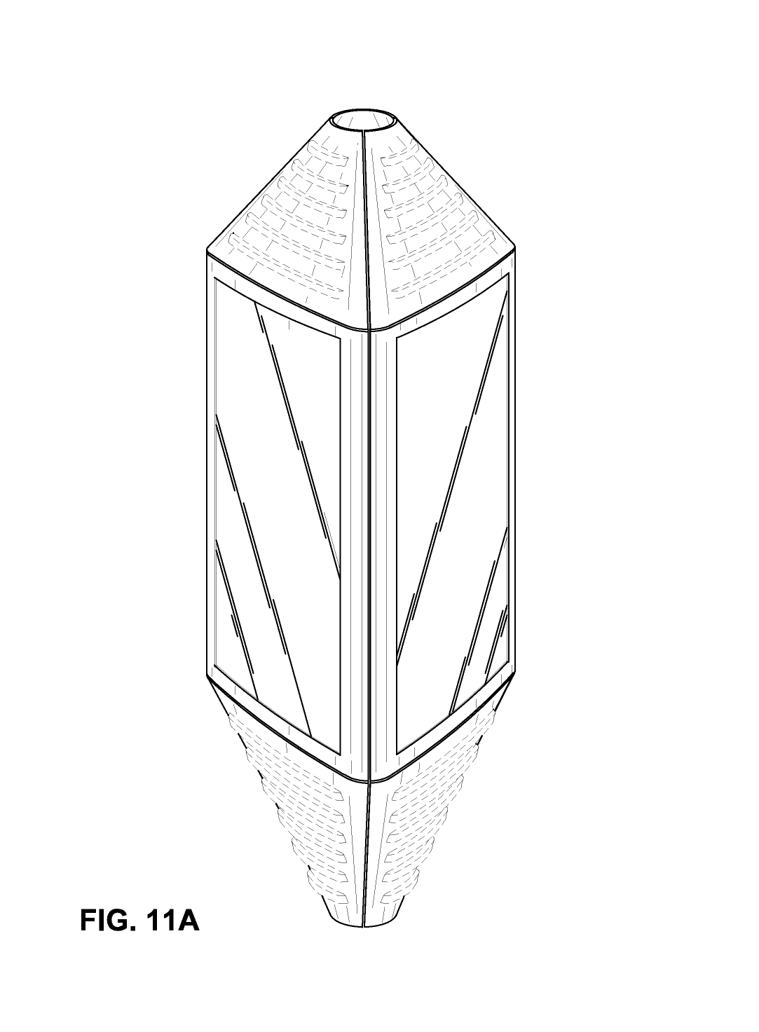

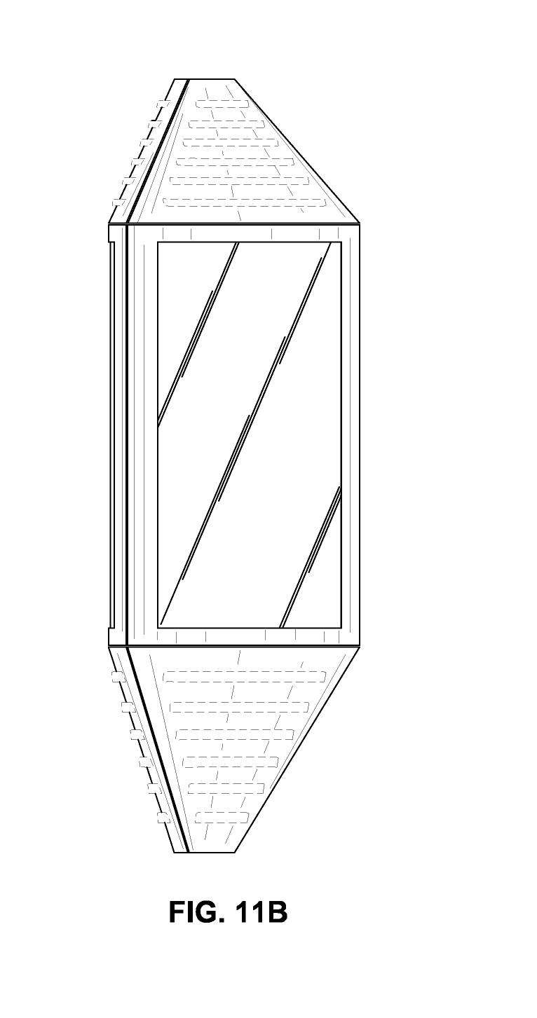

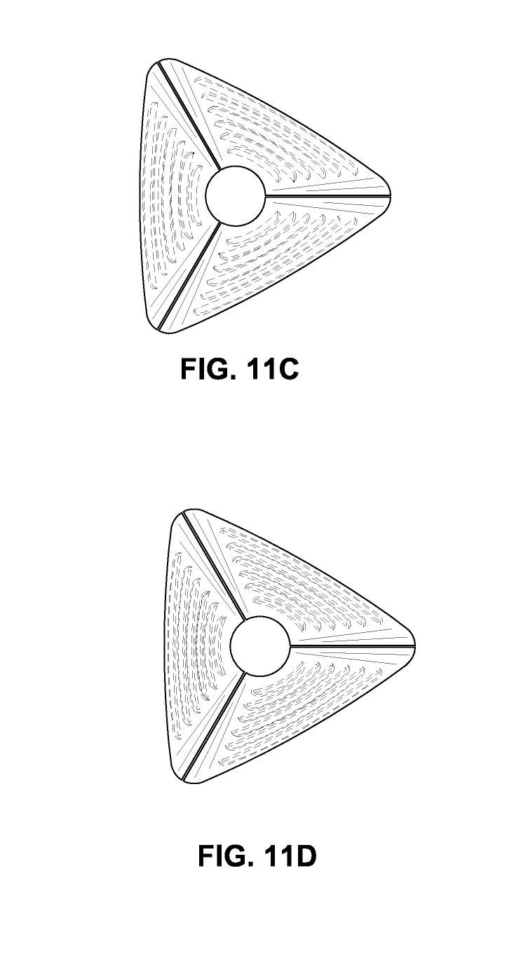

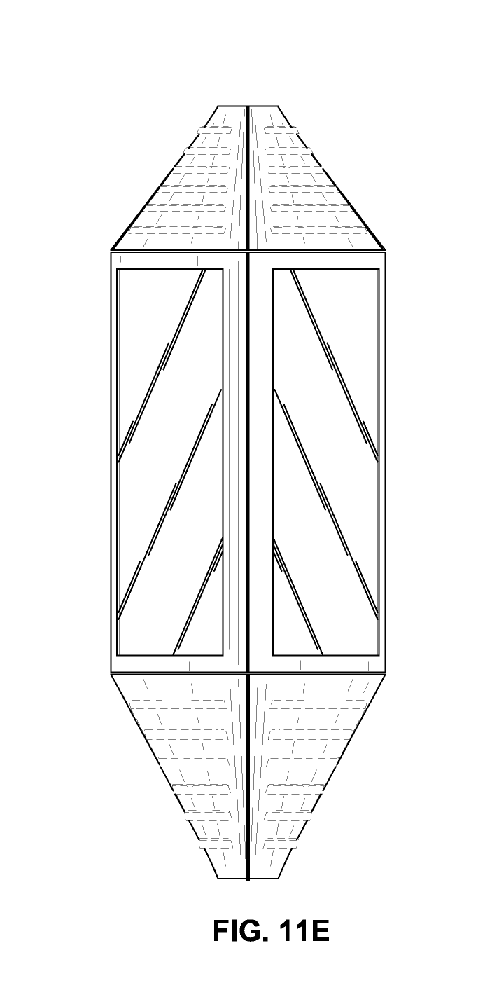

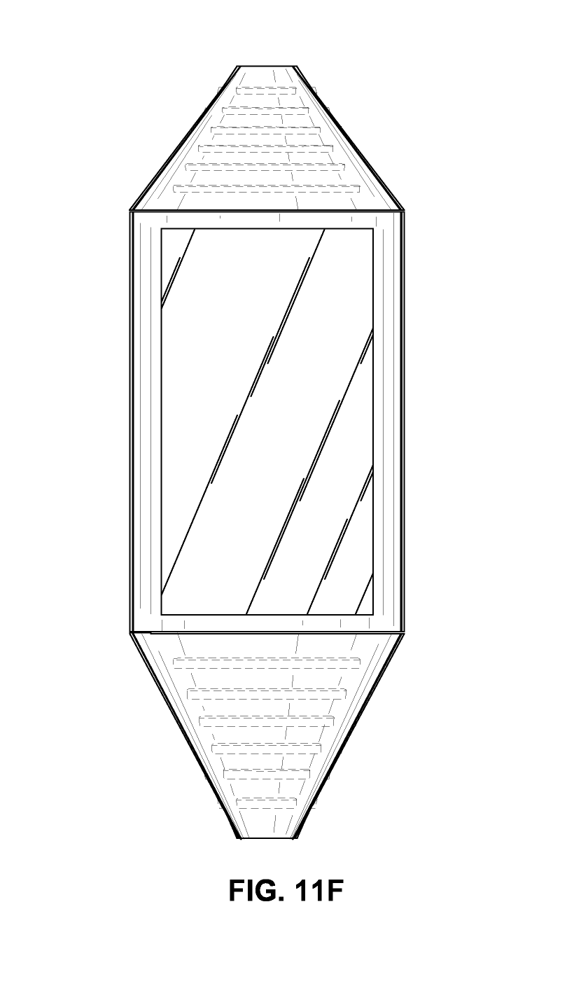

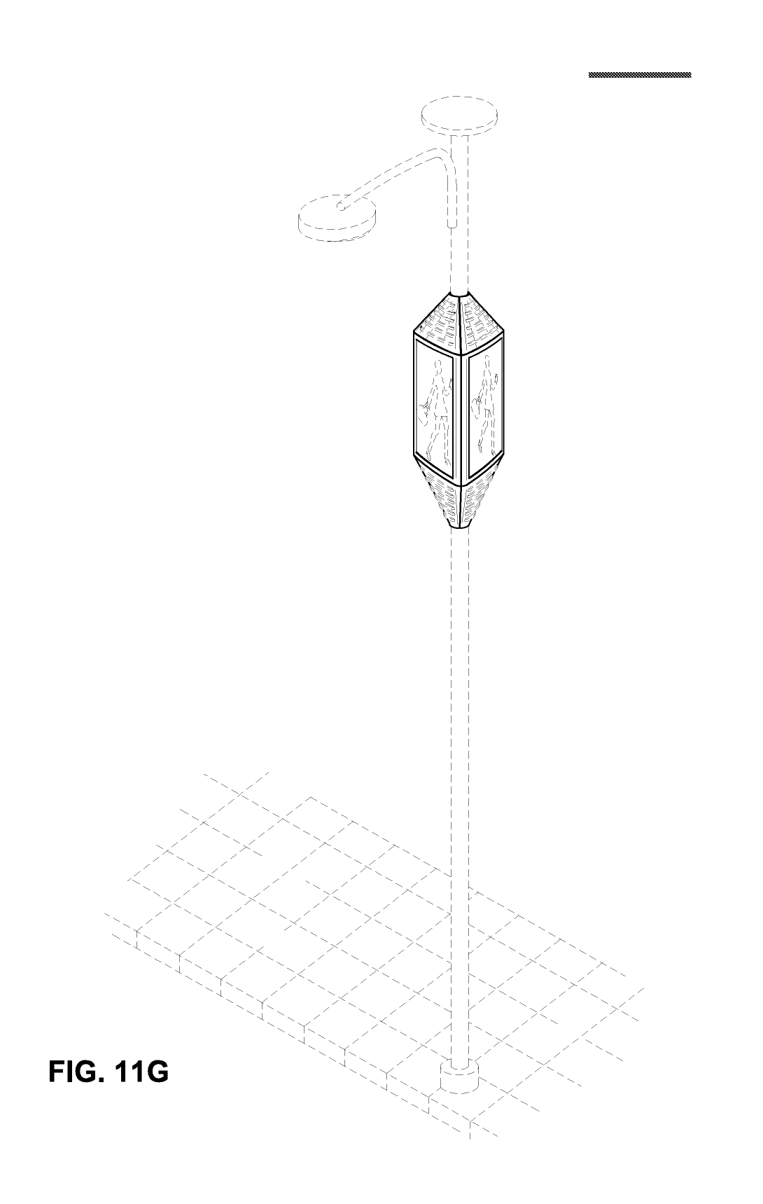

External appearance of the multimedia/multipurpose communications station 20′, and of a telecommunications station enclosure, of an embodiment such as that of FIG. 4 from various vantage points or views is provided in FIG. 11A-FIG. 11F. FIG. 11A is a top left perspective view of a telecommunications station enclosure; FIG. 11B is a front view of the telecommunications station enclosure of FIG. 11A; FIG. 11C is a top view of the telecommunications station enclosure of FIG. 11A; FIG. 11D is a bottom view of the telecommunications station enclosure of FIG. 11A; FIG. 11E is a right side view of the telecommunications station enclosure of FIG. 11A; and, FIG. 11F is a left side view of the telecommunications station enclosure of FIG. 11A. FIG. 11G is a perspective view of the telecommunications station enclosure of FIG. 11A in a municipal environment.

Thus, the technology disclosed herein concerns, among other things, the multimedia/multipurpose communications station 20, the municipal pole structure 40, and a display communications enclosure which facilitates multiple types of uses of a telecommunications station. In a basic form the display communications enclosure comprises a panel assembly configured for attachment to a telecommunications station which is mounted to an existing vertical municipal pole. The panel assembly being configured to essentially conceal the telecommunications station and provide a display.

While in some embodiments the communications enclosure 26 has been designated as a communications enclosure 26, the communications enclosure 26 need not in all embodiments carry or provide a display, e.g., can be non-descript or unadorned.

As a non-limiting example, one aspect of the technology disclosed herein concerns a telecommunications station comprising: a radio base station and a panel assembly. The radio base station communicates over an air interface with wireless terminals, and comprises plural modular units which are connected to a vertical support member. The panel assembly panel assembly is connected to at least one of the plural modules, and comprises plural panels which are positioned to wrap about exterior vertical surfaces of the plural modules of the radio base station to substantially vertically enclose the plural modules. The vertical support member (58) is adapted for attachment to an existing vertical municipal pole.

The technology disclosed thus encompasses the following non-limiting example embodiments, it being understood that features of one or more embodiments may be combined with features of other embodiments even if not directly referencing those other embodiments in the following list.

### Example Embodiment E1

A multipurpose communications station 20, 20′, comprising: a telecommunications station 24 which is adapted to communicate over an air interface with wireless terminals, the telecommunications station being attached to a vertical municipal pole 22; a communications enclosure 26 comprising a panel assembly 30 connected to the telecommunications station and configured to essentially conceal the telecommunications station and provide a display 34. In some embodiments the communications enclosure 26 is also referenced telecommunications station enclosure.

### Example embodiment E1.1

The multipurpose communications station 20, 20′ of embodiment E1, wherein the panel assembly 30 is connectable to the telecommunications station 24 and is configured to conceal the telecommunications station 24 at least partially with the display 34.

### Example Embodiment E1.2

The multipurpose communications station 20, 20′ of embodiment E1, wherein the telecommunications station 24 comprises plural modular 50-55 units which are held aloft by a vertical support block 58 (in other embodiments also referenced as “vertical support block” or as “central support block/member”).

### Example Embodiment E1.3

The multipurpose communications station 20, 20′ of embodiment E1, wherein the panel assembly comprises plural panels 30 which are positioned to substantially vertically enclose the plural modules 50-55, and wherein at least one and preferably more than one of the plural panels 30 bear a same or different signage.

### Example Embodiment E1.4

The multipurpose communications station 20, 20′ of embodiment E1.3, wherein the plural modular units 50-55 are positioned at different angles about the vertical support 58, the vertical support member being centrally arranged with respect to the plural modules and the vertical support member 58 extending along a vertical axis.

### Example Embodiment E1.5

The multipurpose communications station 20, 20′ of embodiment E1.3, wherein the plural panels 30 are connected to one another.

### Example Embodiment E1.6

The multipurpose communications station 20, 20′ of embodiment E1.3, wherein one of the plural panels 30 is an anchor panel 30A and one of the plural modules 50-55 is an anchor module 51, wherein the anchor panel is mounted to the anchor module, and wherein others of the plural panels are connected to the anchor panel.

### Example Embodiment E1.7

The multipurpose communications station 20, 20′ of embodiment E1.3, wherein the plural panels 30 are connected to one another by hinges 72 so that the panel assembly is wrapped about exterior vertical surfaces of the plural modules 50-55 of the telecommunications station 24.

### Example Embodiment E1.8

The multipurpose communications station 20, 20′ of embodiment E1.3, wherein the plural panels 30 are connected in a manner whereby the panel assembly in a horizontal plane forms a geometric shape about the vertical support member 58.

### Example Embodiment E1.9

The multipurpose communications station of embodiment E1.8, wherein the geometric shape is a triangle.

### Example Embodiment E1.10

The multipurpose communications station 20, 20′ of embodiment E1.8, wherein the geometrical shape is configured to have sides which are parallel to vertical surfaces of the plural modules 50-55 which are surrounded by the panel assembly.

### Example Embodiment E1.11

The multipurpose communications station 20, 20′ of embodiment E1, wherein the vertical support member 58 is adapted for attachment to the vertical municipal pole 22, such as a light pole or a utility pole.

### Example Embodiment E1.12

The multipurpose communications station 20, 20′ of embodiment E1, wherein the vertical support member 58 is adapted for attachment about the periphery of the vertical municipal pole 22, such as a light pole or a utility pole.

### Example Embodiment E1.13

The multipurpose communications station 20, 20′ of embodiment E1, wherein at least one of the panels 30 comprises glass fiber with a Gelcote outer finish.

### Example Embodiment E1.14

The multipurpose communications station 20, 20′ of embodiment E1, wherein at least one panel 30 of the panel assembly comprises an at least semi-translucent panel section which bears the display 34.

### Example Embodiment E1.15

The multipurpose communications station 20, 20′ of embodiment E1, wherein the display is oriented to be viewed from an exterior of the panel assembly, and further comprising an illumination source assembly for directing light toward the translucent panel section.

### Example Embodiment E1.16

The multipurpose communications station 20, 20′ of embodiment E1.15, further comprising a common power supply that powers the illumination source and the telecommunications station.

### Example Embodiment E1.17

The multipurpose communications station 20, 20′ of embodiment E1.15, wherein the illumination source is a LED illumination source 114.

### Example Embodiment E1.18

The multipurpose communications station 20, 20′ of embodiment E1.15, further comprising a solar panel which provides power for the illumination source.

### Example embodiment E1.19

The multipurpose communications station 20, 20′ of embodiment E1.18, wherein the solar panel is carried by the panel assembly.

### Example Embodiment E1.20

The multipurpose communications station 20, 20′ of embodiment E1, wherein at least one panel 30 of the panel assembly comprises a panel assembly which is driven/programmed to provide the display.

### Example Embodiment E1.21

The multipurpose communications station 20, 20′ of embodiment E1.20, further comprising a communication module through which the panel assembly is remotely programmed/driven to provide the display.

### Example Embodiment E1.22

The multipurpose communications station 20, 20′ of embodiment E1.21, wherein the communication module receives signals from the telecommunications station/communications station for programming/driving the panel for providing the display.

### Example Embodiment E1.23

The multipurpose communications station 20, 20′ of embodiment E1, wherein the display comprises advertising.

### Example Embodiment E1.24

The multipurpose communications station 20, 20′ of embodiment E1, wherein the display comprises a municipal advisory notification (such as a traffic advisory).

### Example Embodiment E1.25

The multipurpose communications station 20, 20′ of embodiment E1, wherein the panel assembly is configured with means for ventilating the telecommunications station.

### Example Embodiment E1.26

The multipurpose communications station 20, 20′ of embodiment E1.25, wherein the ventilating means comprises at least one of a vent 84 and a screen 98.

### Example Embodiment E1.27

The multipurpose communications station 20, 20′ of embodiment E1, wherein one or more of the plural panels is provided with vents 84 for facilitating air passage 86 to the telecommunications station 24.

### Example Embodiment E1.28

The multipurpose communications station 20, 20′ of embodiment E1, wherein the panel assembly comprises a cap 90 which encloses the panel assembly horizontally above the telecommunications station 24 and a skirt 92 which encloses the panel assembly horizontally below the telecommunications station.

### Example Embodiment E1.29

The multipurpose communications station 20, 20′ of embodiment E1.28, wherein at increasing distances from a horizontal center of the panel assembly the cap 90 and the skirt 92 taper in horizontal cross sections from the plural panels 30 toward a vertical center of the panel assembly.

### Example Embodiment E1.30

The multipurpose communications station 20, 20′ of embodiment E1.28, wherein at least one of the cap 90 and the skirt 92 have an essentially conical shape.

### Example Embodiment E1.31

The multipurpose communications station 20, 20′ of embodiment E1.28, further comprising means provided in at least one of the cap 90 and the skirt 92 for ventilating the telecommunications station.

### Example Embodiment E2

A telecommunications station 20, 20′ comprising:

a radio base station 24 which is adapted to communicate over an air interface with wireless terminals, the radio base station comprising plural modular units 50-55 which are held aloft by a vertical support block 58;
a communications enclosure comprising a panel assembly connected to at least one of the plural modules, the panel assembly comprising plural panels 30 which are positioned to wrap about exterior vertical surfaces of the plural modules of the radio base station to substantially vertically enclose the plural modules; and
wherein the vertical support member 58 is adapted for attachment to an existing vertical municipal pole 22. In some embodiments, the communications enclosure is referenced as a telecommunications station enclosure.

### Example Embodiment E2.1

### Embodiment E2.1

The telecommunications station 20, 20′ of example embodiment E2, wherein one of the plural panels 30 is an anchor panel 30A and one of the plural modules 50-55 is an anchor module 51, wherein the anchor panel is mounted to the anchor module, and wherein others of the plural panels are connected to the anchor panel.

### Example Embodiment E2.2

The telecommunications station 20, 20′ of example embodiment E2.1, wherein the plural panels 30 are connected to one another by hinges 72 so that the plural panels are wrapped about the exterior vertical surfaces of the plural modules of the telecommunications station 24.

### Example Embodiment E2.3

The telecommunications station 20, 20′ of example embodiment E2, wherein the plural panels 30 are connected in a manner whereby the panel assembly in a horizontal plane forms a geometric shape about the vertical support member.

### Example Embodiment E2.4

The telecommunications station 20, 20′ of example embodiment E2.3, wherein the geometric shape is a triangle.

### Example Embodiment E2.5

The telecommunications station 20, 20′ of example embodiment E2.3, wherein the geometrical shape is configured to have sides which are parallel to vertical surfaces of the plural modules 50-55 surrounded by the panel assembly.

### Example Embodiment E2.6

The telecommunications station 20, 20′ of example embodiment E2, wherein the plural panels 30 are connected to one another by hinges 72.

### Example Embodiment E2.7

The telecommunications station 20, 20′ of example embodiment E2, wherein at least one and preferably more than one of the plural panels 30 bear a same or different signage.

### Example E3

A structure for facilitating multiple types of uses of a telecommunications station, the structure comprising: a panel assembly configured for attachment to a telecommunications station 24 which is mounted to an existing vertical municipal pole 22; the panel assembly being configured to essentially conceal the telecommunications station and provide a display 34.

### Example E3.1

The structure of example E3, the panel assembly comprising plural panels which are positioned to wrap about exterior vertical surfaces of plural modules 50-55 comprising the telecommunications station 24 to substantially vertically enclose the plural modules.

### Example E3.2

The structure of example E3, wherein the plural panels 30 are connected to one another by hinges 72 so that the plural panels are wrapped about the exterior vertical surfaces of the plural modules 50-55 of the telecommunications station 24.

### Example E3.3

The structure of example E3, wherein the plural panels 30 are connected in a manner whereby the panel assembly in a horizontal plane forms a geometric shape about the vertical municipal pole.

### Example E3.4

The structure of example E3.3, wherein the geometric shape is a triangle.

### Example E3.5

The structure of example E3.3, wherein the geometrical shape is configured to have sides which are parallel to vertical surfaces of the plural modules 50-55 of the communications system 24 which are surrounded by the panel assembly.

### Example E3.6

The structure of example E3, wherein the plural panels 30 are connected to one another by hinges 72.

### Example E3.7

The structure of example E3, wherein at least one and preferably more than one of the plural panels 30 bear a same or different signage.

### Example E3.8

The structure of example E3, wherein the panel assembly is mounted aloft on the existing municipal pole 22 at an altitude determined by visibility of signage and effectiveness of radio communications transceived by the telecommunications station 24.

### Example E3.9

The structure of example E3, wherein the panel assembly is mounted aloft on the existing municipal pole 22 approximately three meters above ground level.

### Example Embodiment E4

A municipal pole structure 40 comprising:

a vertically extending pole 22;
a municipal utility service unit 42 positioned aloft on the pole;
a telecommunications station 24 which communicates over an air interface with wireless terminals, the telecommunications station being attached to the pole;
a panel assembly connected to the telecommunications station and configured to essentially conceal the telecommunications station and provide a display 34.

### Example Embodiment E4.1

The municipal pole structure 40 of example embodiment E4, wherein the municipal utility service unit 42 is a luminary device.

### Example Embodiment E4.2

The municipal pole structure 40 of example embodiment E4, wherein the municipal utility service unit 42 is a power transmission device.

### Example Embodiment E4.3

The municipal pole structure 40 of example embodiment E4, further comprising an antenna 44 for the telecommunications station 24 mounted proximate a top of the vertically extending pole.

### Example Embodiment E4.4

The municipal pole structure 40 of example embodiment E4.3, further comprising feeder lines 48 connecting the antenna 44 and the telecommunications station 24, the feeder lines being positioned either on an outside or an inside of the vertically extending pole.

### Example Embodiment E4.5

The municipal pole structure 40 of example embodiment E4, wherein the panel assembly is connected to the telecommunications station and configured to conceal the telecommunications station at least partially with the display 34.

Although the description above contains many specificities, these should not be construed as limiting the scope of the invention but as merely providing illustrations of some of the presently preferred embodiments of this invention. It will be appreciated that the scope of the present invention fully encompasses other embodiments which may become obvious to those skilled in the art, and that the scope of the present invention is accordingly not to be limited. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for a device or method to address each and every problem sought to be solved by the present invention, for it to be encompassed hereby.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims.

1-37. (canceled)

38. A telecommunications station enclosure comprising:
a panel assembly configured to essentially conceal a telecommunications station, wherein the panel assembly is configured to conceal the telecommunications station with a sign or display;
wherein the telecommunications station is mounted around a vertical pole; and
wherein the panel assembly comprises plural panels that are connected to one another by hinges so that the panel assembly is wrapped about exterior vertical surfaces of the plural modules of the telecommunications station.

39. The telecommunications station enclosure of claim 38, wherein the panel assembly is configured to be mounted on the vertical pole.

40. The telecommunications station enclosure of claim 38, further comprising a vertical support member adapted for attachment to the vertical pole.

41. The telecommunications station enclosure of claim 38, wherein plural modular units are positioned at different angles about the vertical support member, the vertical support member being centrally arranged with respect to the plural modules and the vertical support member extending along a vertical axis.

42. The telecommunications station enclosure of claim 38, wherein one of the plural panels is an anchor panel and one of the plural modules is an anchor module, wherein the anchor panel is mounted to the anchor module, and wherein others of the plural panels are connected to the anchor panel.

43. The telecommunications station enclosure of claim 38, wherein the plural panels are mounted in a manner whereby the panel assembly in a horizontal plane forms a geometric shape about the vertical support member.

44. The telecommunications station enclosure of claim 38, wherein at least one panel of the panel assembly comprises an at least semi-translucent panel section which bears the display.

45. The telecommunications station enclosure of claim 38, wherein the display is oriented to be viewed from an exterior of the panel assembly, and further comprising an illumination source assembly for directing light toward the translucent panel section.

46. The telecommunications station enclosure of claim 45, further comprising a common power supply that is adapted to power the illumination source and the telecommunications station.

47. The telecommunications station enclosure of claim 45, further comprising a solar panel that provides power for the illumination source.

48. The telecommunications station enclosure of claim 38, wherein at least one panel of the panel assembly comprises a panel assembly that is driven/programmed to provide the display.

49. The telecommunications station enclosure of claim 48, further comprising a communication module through which the panel assembly is remotely programmed/driven to provide the display.

50. The telecommunications station enclosure of claim 49, wherein the communication module is configured to receive signals from the telecommunications station/communications station for programming/driving the panel for providing the display.

51. The telecommunications station enclosure of claim 38, wherein the display comprises advertising or a municipal advisory notification.

52. The telecommunications station enclosure of claim 38, wherein the panel assembly is configured with means for ventilating the telecommunications station.

53. The telecommunications station enclosure of claim 38, wherein the panel assembly comprises a cap that encloses the panel assembly horizontally above the telecommunications station and a skirt that encloses the panel assembly horizontally below the telecommunications station.

54. The telecommunications station enclosure of claim 38, wherein the panel assembly is mounted aloft on the vertical pole at an altitude determined by visibility of signage and effectiveness of radio communications transceived by the telecommunications station.

55. A municipal pole structure used for carrying a telecommunications station and the telecommunications station enclosure of claim 38, wherein the municipal pole structure is adapted to allow firmly attachment to the ground.

56. The municipal pole structure of claim 55, further comprising an antenna for the telecommunications station mounted proximate a top of the vertically extending pole.

57. The municipal pole structure of claim 55, further comprising feeder lines connecting the antenna and the telecommunications station, the feeder lines being positioned either on an outside or an inside of the vertically extending pole.
